(19) United States
(12) Patent Application Publication
(10) Pub. No.: US 2019/0118722 A1
(43) Pub. Date: Apr. 25, 2019

(54) PROTECTIVE DEVICE WITH AN AXIALLY ACTING DAMPING

(71) Applicants: William POMPILI, Shelby Township, MI (US); Ralf GROCHOWSKI, Rochester Hills, MI (US); Carsten MEYER, Kirchheim unter Teck (DE)

(72) Inventors: William POMPILI, Shelby Township, MI (US); Ralf GROCHOWSKI, Rochester Hills, MI (US); Carsten MEYER, Kirchheim unter Teck (DE)

(21) Appl. No.: 15/793,367

(22) Filed: Oct. 25, 2017

(51) Int. Cl. B60R 5/04; B60R 21/02

(52) U.S. Cl. CPC B60R 5/047; B60R 21/02

(57) ABSTRACT

Protective device for an interior section of a vehicle, including a housing accommodating a bearing shaft for a windable structure which at least partially covers the interior section. Outer face ends of two housing side parts are each fixable in a vehicle-fixed holder, wherein at least one of the housing side parts is movable relative to a housing central part axially in relation to a housing longitudinal axis between a release position and a locking position. The at least one housing side part is movable by a spring force from the release position to the locking position. The at least one housing side part is associated with a damping device configured such that, during a movement of the housing side part by spring force, the damping device exerts a damping force on the housing side part counteracting the spring force.

### FIELD OF THE INVENTION

The invention relates to a protective device for an interior section of an automotive vehicle, comprising a housing which is prepared for accommodation of a bearing shaft for a two-dimensional structure to be wound up and off thereon for at least partial covering of the interior section, having two housing side parts which are axially assigned to a housing longitudinal axis and configured such that outer face ends of the housing side parts are each fixable in a respective vehicle-fixed holder, wherein at least one of the housing side parts is movable relative to a housing central part axially in relation to the housing longitudinal axis between a release position releasing the respective vehicle-fixed holder and a locking position fixed in the vehicle-fixed holder, wherein the at least one housing side part is movable by means of a spring force from the release position to the locking position.

### BACKGROUND OF THE INVENTION

Such a protective device is known from DE 29 41 711 A1 in the form of a loading compartment covering for a loading compartment of an automotive vehicle. The known protective device includes two cup-type housing side parts which are each fixable with their outer face ends in a corresponding holding recess fixed to the vehicle. The vehicle-fixed holding recesses are arranged in the loading compartment of the vehicle such that the housing longitudinal axis of the protective device in a fixed condition, wherein the housing side parts are oriented axially in relation to said housing longitudinal axis, extends horizontally and transversely to the vehicle longitudinal direction over the width of the loading compartment. In order to allow inserting and removing of the protective device into and from the vehicle-fixed holding recesses, at least one of the housing side parts is held movable axially in relation to the housing longitudinal axis by spring loading. For inserting the protective device into the holding recesses, the movably held housing side part is pressed manually inwards along the housing longitudinal axis counter the spring load into a release position, whereby the axial distance between the outer face ends of the two housing side parts is reduced. As a result, the total length of the protective device is reduced to a value that is smaller than the axial distance of the vehicle-related holding recesses. In such a manner, the protective device can be aligned to be flush with the holding recesses. Subsequently, the movable housing side part is relieved from the inwards oriented manual pressing force, whereby the spring load moves the housing side part axially outwards to a locking position. As a result, the protective device is fixed in the vehicle-fixed holding recesses in that the outer face ends are urged into the respective corresponding holding recess by the spring load. Accordingly, securing the protective device against unintended removal from the holding recesses is exclusively by the spring load acting on the housing side parts. For removal of the protective device from the holding recesses, the movable housing side part is again pressed manually inwards counter the spring load up to a release position. As a result, the distance between the face ends of the housing side parts and, finally, the total length of the protective device is reduced such that said device can be taken off the vehicle-fixed holding recesses. During inserting or removing of the protective device, the manual pressure on the axially movable housing side part counter the spring load has to be maintained continuously. Otherwise, the spring load would inadvertently move the housing side part back to the locking position. Tilting of the protective device between the vehicle-fixed holding recesses could be caused thereby. Also, damaging of the protective device or the holding recesses and injury of the operator cannot be ruled out when the movable housing side part assumes the locking position unexpectedly.

### SUMMARY OF THE INVENTION

An object of the invention is to provide a protective device of the above mentioned type, which ensures simplified handling.

The object is achieved in that at least one housing side part is associated with a damping device which is configured such that, during a movement of the housing side part by the spring force, the damping device exerts a damping force on the housing side part counteracting the spring force. Consequently, the damping force counteracts movement of the axially movable housing side part from the release position to the locking position. If during inserting or removing of the protective device the manually applied pressing force on the movable housing side part counter the spring force is reduced or withdrawn, then the axial movement of the housing side part, caused by the outwards spring force, is slowed down owing to the solution according to the invention. As a result, in case of an uncontrolled withdrawal of the manual pressing force, for example, by an unintentional slipping of the operator during handling of the movable housing side part, an unintentional, abrupt assuming of the locking position is prevented. The risk of injury of the operator and damage of the protective device or the vehicle-fixed holders is obviated in this manner. In case of a controlled withdrawal of the manual pressing force, the operator also has more time for orienting the protective device between the vehicle-fixed holders, owing to the slowed-down movement of the housing side part. In this manner, tilting of the outer face ends of the housing side parts between the vehicle-fixed holders is obviated. As a result, the solution according to the invention ensures particularly simple and secure handling of the protective device. An essentially closed cartridge housing or a largely open frame structure can be provided for a housing. Accordingly, the housing central part can be designed as a tubular or shell-type hollow profile or as a skeleton or framework part.

In an embodiment of the invention, the damping device is configured such that, during a movement of the housing side part counter the spring force, the damping device exerts a damping force on the housing side part supporting the spring force. Consequently, the damping force counteracts movement of the axially movable housing side part from the locking position to the release position. In particular in case of a lateral impact on a vehicle, there can be forces exerted on the protective device, which could cause unintentional release of the face ends from the vehicle-fixed holders, should they be fixed in the holders merely by the spring load. Due to the impact, the thereby unintentionally released protective device can be sent flying through the interior compartment of the vehicle and cause injuries of passengers in the vehicle. Owing to the damping force supporting the spring force, such an unintentional release of the protective device and, finally, a risk of injury of passengers can be obviated. Thus, the damping device is preferably designed as a two-way damping device which counteracts both movement of the movable housing side part axially along the housing longitudinal axis inwards and outwards by deceleration.

What is meant by the indication of an “outwards direction” is a direction essentially along the housing longitudinal axis in the direction towards the outer face end of the movable housing side part. What is meant by the indication of an “inwards direction” is a direction extending essentially opposite thereto. The damping device can carry out a linear damping movement or any other damping movement.

In a further embodiment of the invention, the damping device comprises a rotational damper. Thereby, a rotational damping movement is achieved. As compared to linear dampers, rotational dampers exhibit a more compact structural design. Consequently, an embodiment of the invention with particularly low occupation of available space is obtained. The rotational damper can be provided as one-way or two-way system.

In a further embodiment of the invention, the rotational damper includes a silicone brake. Silicone brakes are well-known and available in most different specifications in relation to the brake momentum and are maintenance-free. As a result, a particularly cost-efficient and reliable embodiment of the invention is achieved.

In a further embodiment of the invention, the rotational damper is attached to the housing central part which is disposed stationary along the housing longitudinal axis.

In a further embodiment of the invention, the housing central part has a cartridge end wall. The cartridge end wall constitutes in the axial direction a closure of the housing central part, designed in particular as a cartridge shell, oriented in the direction towards the outer face end of the movable housing side part. The cartridge end wall is connected to the housing central part using connector means, preferably screws or latching elements. For mounting the damping device, initially the rotational damper can be connected to the cartridge end wall. Subsequently, the cartridge end wall can be arranged on the housing central part and connected thereto. Consequently, a particularly simple to manufacture embodiment of the invention is achieved.

In a further embodiment of the invention, the damping device comprises a toothed rack and a pinion in engagement therewith, which is associated with the rotational damper. The toothed rack extends along the housing longitudinal direction and over a length that corresponds essentially to the axial distance between the release position and the locking position of the outer face end of the movable housing side part. Advantageously, the toothed rack is connected to the movable housing side part and, thus, axially movable together with said housing side part. Accordingly, during an axial movement of the housing side part, an axial movement of the toothed rack is caused. Via the engagement of the toothed rack and the pinion, which is advantageously in the type of a rolling contact, an axial movement of the housing side part causes a rotational movement of the pinion. By means of the rotational damper, the rotational movement of the pinion and, thus finally, the axial movement of the movable housing side part can be damped with a particularly low occupation of available space. The damping force can be transferred to the movable housing side part in a particularly reliable manner, owing to the engagement of pinion and toothed rack.

In a further embodiment of the invention, the toothed rack is an integral part to the at least one housing side part. Thus, the at least one axially movable housing side part comprises the toothed rack. Advantageously, the housing side part together with the toothed rack is made of a plastics material, for example using injection molding. In this manner, a particularly simple to produce embodiment of the invention can be achieved.

In a further embodiment of the invention, the protective device is configured in the form of a loading compartment covering for a loading compartment of a passenger vehicle such that the housing is prepared for accommodation of a bearing shaft for a covering roller blind to be wound up and off thereon for at least partial covering of the loading compartment, and in that further the outer face ends of the housing side parts are each fixable in a respective vehicle-fixed holder, which holders are disposed on opposite side walls of the loading compartment transversely to a vehicle longitudinal direction.

### BRIEF DESCRIPTION OF THE DRAWINGS

Further advantages and features of the invention will become apparent from the claims and also from the description below of a preferred exemplary embodiment of the invention, illustrated below with reference to the figures.

FIG. 1 shows a perspective view of a section of an interior of an automotive vehicle including a preferred embodiment of a protective device according to the invention;

FIG. 2 shows a perspective exploded view of the protective device according to FIG. 1 in the region of a movable housing side part;

FIG. 3 shows an enlarged portion of the protective device according to FIG. 1 in a top view, wherein the movable housing side part assumes a release position;

FIG. 4 shows an enlarged portion of the protective device according to FIG. 1 in a top view, wherein the movable housing side part assumes a locking position;

FIG. 5 shows a perspective partial view of the damping device of the protective device according to the invention according to FIG. 1 together with adjacent components in a release position; and

FIG. 6 shows a perspective partial view of the damping device of the protective device according to the invention according to FIG. 1 together with adjacent components in a locking position.

### DETAILED DESCRIPTION

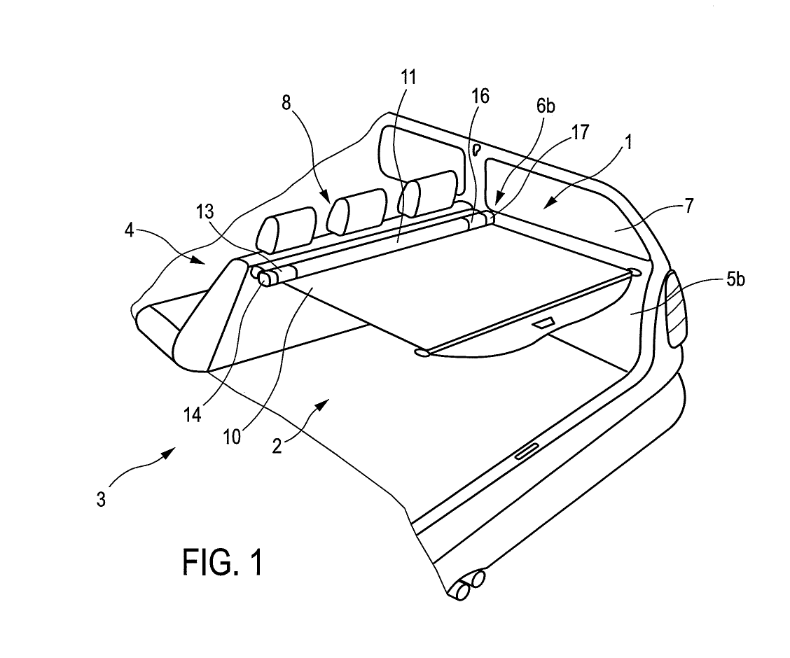

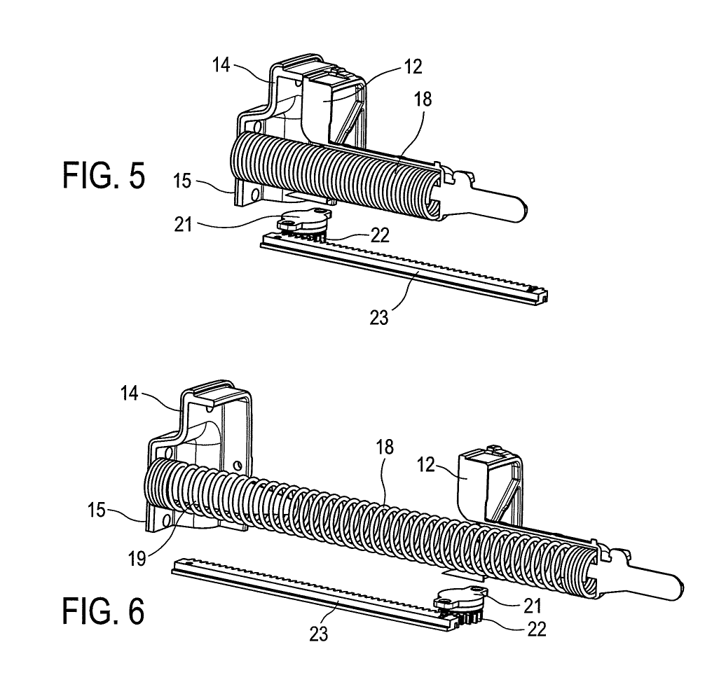

A protective device (1) according to FIG. 1 to FIG. 6 is intended for an interior section (2) of an automotive vehicle (3). According to FIG. 1, the vehicle (3) includes an interior section (2) adjoining a row of seats (4) in the form of a loading compartment. The loading compartment (2) is accessible from the exterior on a rear end of the vehicle via a tailgate, in a generally well-known manner, and has side walls (5a, 5b) disposed opposite in the transverse direction of the vehicle and extending essentially in the vertical, each side wall provided with a vehicle-fixed holder (6a, 6b), wherein for the sake of clarity, merely one side wall (5b) together with the respective holder (6b) is illustrated in FIG. 1. The vehicle-fixed holders (6a, 6b) are configured for accommodation of the protective device (1). The loading compartment (2) is coverable by the protective device (1) such that the protective device (1), in an extended functional condition, as illustrated with reference to FIG. 1, covers the loading compartment (2) essentially over the width and length thereof below a waistline constituted by the bottom edge of a side window (7) towards the top.

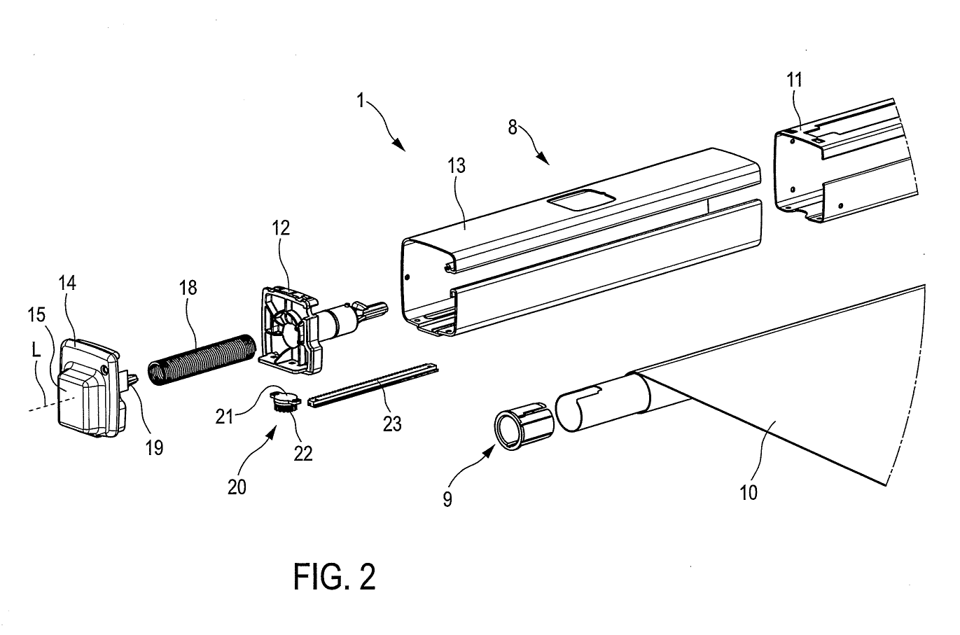

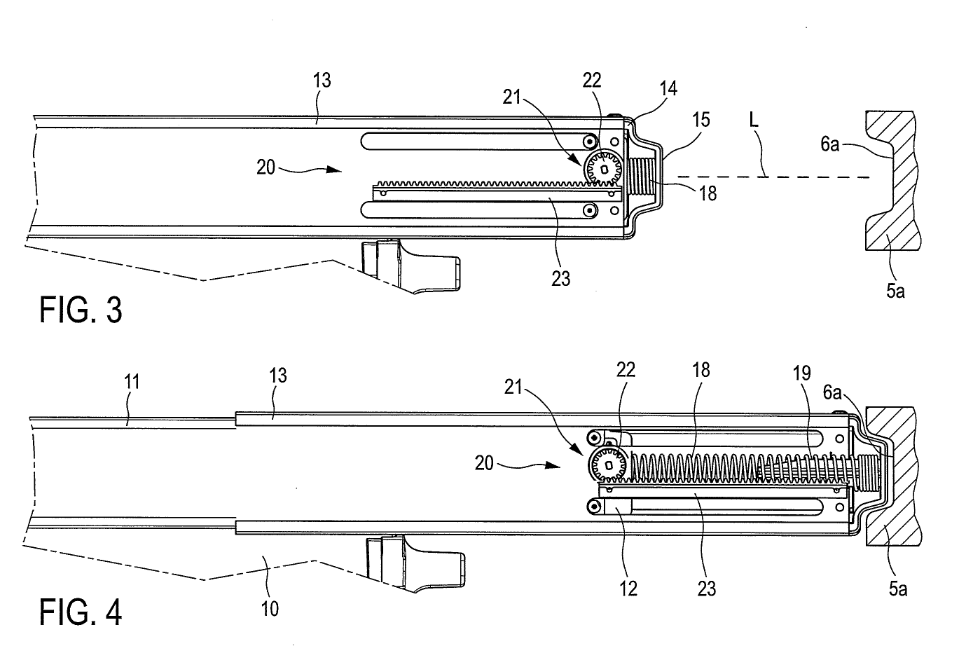

The protective device (1) in the form of a loading compartment has a housing (8) which is prepared for accommodation of a bearing shaft (9), as illustrated with reference to FIG. 2, for a two-dimensional structure (10) to be wound up and off thereon. The housing (8) comprises a cartridge shell (11) arranged stationary in relation to a housing longitudinal axis (L), also referred to as housing central part, a cartridge end wall (12) forming a face-sided closure of the cartridge shell (11) and a housing side part (13) movable along the housing longitudinal axis (L), which side part is on one side coaxially arranged on the cartridge shell (11) and overlapping said shell on a face side. An outer face end (14) forms the axial closure of the axially movable housing side part (13) and is configured such that it is fixable in the vehicle-fixed holder (6a), as illustrated in more detail with reference to FIG. 3 and FIG. 4. For that purpose, the outer face end (14) has an outwards protruding location pin (15) which is essentially complementary to the vehicle-fixed holder (6a).

On the face side of the cartridge shell (11) opposite the movable housing side part (13) the housing (8) comprises another housing side part (16) which is disposed axially stationary in relation to the housing longitudinal axis (L) and overlaps the cartridge shell (11), starting from the opposite face side, correspondingly inverted to the movable housing side part (13). The axially stationary disposed housing side part (16) includes, in analogy to the movable housing side part (13), an outer face end (17) with an outwards protruding location pin and is fixable in the vehicle-fixed holder (6b) which is designed in analogy to the vehicle-fixed holder (6a) and located opposite thereto. In a mounted condition, wherein the outer face ends (14, 17) of the housing (8) are fixed in the respective vehicle-fixed holders (6a, 6b), the protective device (1) extends transversely to the vehicle longitudinal direction and horizontally over the width of the loading compartment of the vehicle (3).

A spring (18) oriented coaxially in relation to the housing longitudinal axis (L) is disposed between the outer face end (14) of the movable housing side part (13) and the cartridge end wall (12), wherein the spring (18) is axially supported on one end on a seat formed by an exterior surface of the cartridge end wall (12) and on the other end on a seat formed by an interior surface of the face end (14). The spring (18) is a compression spring and radially fixed on a cylindrical spike (19) protruding from the interior surface of the face end (14). Correspondingly, the movable housing side part (13) is movable axially in relation to the housing longitudinal axis (L) between a release position releasing the vehicle-fixed holder (6a), as illustrated with reference to FIG. 3, and a locking position fixed in the vehicle-fixed holder (6a), as illustrated with reference to FIG. 4. Therein, the movable housing side part (13) is movable by means of the spring force caused by the spring (18) from the release position to the locking position.

For inserting the protective device (1) into the vehicle-fixed holders (6a, 6b), the movable housing side part (13) is pressed manually inwards along the housing longitudinal axis (L) and counter the outwards oriented spring load caused by the spring (18) into the release position. As a result, the axial distance between the outer face ends (14, 17) of the housing (8) and, thus, the total length of the protective device (1) is reduced to a value that is smaller than the axial distance between the two vehicle-fixed holders (6a, 6b). In such a manner, the protective device (1) can be aligned to be flush with the holders. Subsequently, the movable housing'side part (13) is relieved from the inwards oriented manual pressing force, whereby the spring force of the spring (18), directed outwards in the direction of the vehicle-fixed holder (6a), moves the movable housing side part (13) axially outwards to the locking position. In that the outer face end (14) of the movable housing side part (13) is pressed into the holder (6a) by means of the spring (18) and a corresponding counterforce is caused on the outer face end (17) of the axially stationary housing side part (16) aligned in the opposite holder (6b), the protective device (1) is fixed in the loading compartment (2).

For removing the protective device (1), the movable housing side part (13) is again pressed manually inwards counter the spring load caused by the spring (18) towards the release position. As a result, the distance between the face end (14) of the movable housing side part (13) and the face end (17) of the opposite, axially stationary housing side part (16) is again reduced and, thus, the total length of the protective device (1) is reduced such that the protective device can be taken off the vehicle-fixed holder (6a) and the holder (6b) opposite thereto.

The protective device (1) according to FIG. 1 to FIG. 6 also includes a damping device (20). The damping device (20) is assigned to the axially movable housing side part (13) and configured such that, during a movement of the axially movable housing side part (13) by means of the spring (18), the damping device exerts a damping force on the housing side part (13) counteracting the spring force. For that purpose, the damping device (20) comprises a rotational damper (21) in the form of a silicone brake having a protruding rotational shaft, not illustrated in more detail, a pinion (22) fixed on the rotational shaft, and a toothed rack (23) in engagement with the pinion (22). The rotational damper (21) is attached to the cartridge end wall (12) using connector means, not illustrated in more detail, and, thus, is disposed stationary along the housing longitudinal axis (L). The toothed rack (23) extends in the direction of the housing longitudinal axis (L) and is attached to the movable housing side part (13) and, thus, movable axially together with said part along the housing longitudinal axis (L). The toothed rack (23) extends over a length, with the amount thereof corresponding essentially to the axial displacement of the outer face end (14) during a movement between the release position and the locking position.

Starting from the release position, as illustrated with reference to FIG. 3, and after the above described withdrawal of the manually applied pressing force for inserting the protective device (1), the spring (18) causes an axial movement of the housing side part (13) and the toothed rack (23) fixed thereto in the direction towards the locking position. As a consequence of the rolling contact between the toothed rack (23) and the pinion (22) fixed on the rotational shaft of the rotational damper (21), the pinion (22) is moved in a counter-clockwise rotatory motion. The kinetic energy transferred thereby to the rotational shaft of the rotational damper (21) is at least partially transformed into thermal energy by the rotational damper (21). As a result, a brake momentum is caused on the rotational shaft of the rotational damper (21) counter the rotational movement of the pinion (22). As a consequence of the rolling contact between the toothed rack (23) and the pinion (22), the brake momentum causes a brake force acting along the housing longitudinal axis (L) to damp the axial movement of the toothed rack (23) and, thus finally, the axial movement of the housing side part (13). As compared to an undamped movement, a movement of the movable housing side part (13) subject to such damping is accordingly slowed down.

The damping device (20) is further configured such that, during a movement of the housing side part (13) counter the spring force, the damping device exerts a damping force on the housing side part (13) supporting the spring force. For that purpose, the rotational damper (21) is configured such that the damper generates a brake momentum, independent of the sense of rotation of the rotational shaft.

1. Protective device for an interior section of an automotive vehicle, comprising a housing prepared for accommodation of a bearing shaft for a two-dimensional structure to be wound up and off thereon for at least partial covering of the interior section, having two housing side parts which are axially assigned to a housing longitudinal axis and configured such that outer face ends of the housing side parts are each fixable in a respective vehicle-fixed holder, wherein at least one of the housing side parts is movable relative to a housing central part axially in relation to the housing longitudinal axis between a release position releasing the respective vehicle-fixed holder and a locking position fixed in the vehicle-fixed holder, wherein the at least one housing side part is movable by means of a spring force from the release position to the locking position,
wherein
the at least one housing side part is associated with a damping device which is configured such that, during a movement of the housing side part by the spring force, the damping device exerts a damping force on the housing side part counteracting the spring force.

2. Protective device according to claim 1, wherein the damping device is configured such that, during a movement of the housing side part counter the spring force, the damping device exerts a damping force on the housing side part supporting the spring force.

3. Protective device according to claim 1, wherein the damping device comprises a rotational damper.

4. Protective device according to claim 3, wherein the rotational damper includes a silicone brake.

5. Protective device according to claim 3, wherein the rotational damper is attached to the housing central part which is disposed stationary along the housing longitudinal axis.

6. Protective device according to claim 1, wherein the housing central part has a cartridge end wall.

7. Protective device according to claim 1, wherein the damping device comprises a toothed rack and a pinion in engagement therewith, which is associated with the rotational damper.

8. Protective device according to claim 7, wherein the toothed rack is an integral part to the at least one housing side part.

9. Protective device according to claim 1, wherein said device is in the form of a loading compartment covering for a loading compartment of a passenger vehicle such that the housing is prepared for accommodation of a bearing shaft for a covering roller blind to be wound up and off thereon for at least partial covering of the loading compartment, and the outer face ends of the housing side parts are each fixable in a respective vehicle-fixed holder, which holders are disposed on opposite side walls of the loading compartment transversely to a vehicle longitudinal direction.
